(19) United States
(12) Patent Application Publication
(10) Pub. No.: US 2010/0231158 A1
(43) Pub. Date: Sep. 16, 2010

(54) SERVER CONTROLLER AND A METHOD FOR CONTROLLING A PLURALITY OF MOTORS

(75) Inventor: Ingvar Jonsson, Vasteras (SE)

Correspondence Address: VENABLE LLP, P.O. BOX 34385, WASHINGTON, DC, 20043-9998, US

(73) Assignee: ABB Technology AB, Vasteras (SE)

(21) Appl. No.: 12/306,723

(22) PCT Filed: Dec. 28, 2007
(86) PCT No.: PCT/EP07/64603

§ 371 Date: Dec. 27, 2008

(51) Int. Cl. G05B 11/42; G05B 11/32

(52) U.S. Cl. 318/609; 318/625

(57) ABSTRACT

Servo controller for controlling a plurality of motors including a master motor and a slave motor cooperatively driving a movable member. The servo controller is configured to control the master motor and the slave motor based on position references for the master motor. The servo controller includes a master speed controller configured to calculate a reference torque for the master motor based on speed errors for the master motor. The slave speed controller is configured to calculate reference torques for the slave motor based on speed errors for the slave motor. Each of the reference torques includes a proportional torque part and an integral torque part. The servo controller is configured to calculate each of the integral torque parts based on the speed errors of the master motor and the speed errors of the slave motor, such that the torques due to the integral torque parts will be distributed equally between the master and slave motors or according to a predefined ratio.

### FIELD OF THE INVENTION

The present invention relates to a server controller for controlling a plurality of motors including a master motor and a slave motor cooperatively driving a movable member.

The present invention also relates to a method for server control of at least two motors cooperatively driving a movable member.

### PRIOR ART

In drive mechanisms for robots, machine tools, injection molding machines, pressing machines, positioners, etc., it is often the case that a movable member to be actuated is too large in size to be accelerated or decelerated by a single motor for driving the movable member. In such cases, two or more motors are used for cooperatively driving the movable member. When performing the control of the motors, drive shafts of the individual motors need to be subjected to position control.

It is well known to use servo controllers for controlling the position of a motor. For example, a servo controller for controlling a motor driving the motion of a robot arm includes a position controller configured to calculate speed references based on a position error, which is calculated as the difference between position references from a main computer of the robot and measured positions from a position detector. The servo controller further includes a speed controller configured to calculate reference torques for the motor based on the difference between the speed references from the position controller and measured velocities, instance calculated based on the measured positions, and a current controller configured to provide the motor with current based on the torque references from the speed controller. Traditionally, the speed controller is a PID (Proportional Integration Derivation) controller, or a PI (Proportional Integration) controller. The PI or PID controller includes a proportional element configured to calculate a reference torque part based on a proportional constant and the speed error, and an integral torque element configured to calculate a reference torque based on the integral of the speed error. The total reference torque is calculated as the sum of the reference torques part and the integral torque part.

U.S. Pat. No. 5,086,263 discloses a driving apparatus including two motors. The driving apparatus includes a servo controller configured to control both motors based on a common position instruction signal. The servo controller includes two deviation counters configured to generate position error signals for both motors based on the position instruction signal and detection signals from respective rotation detecting devices. The servo controller includes a correcting unit to which the position error signals outputted from respective deviation counters are applied, so as to form correction signals with respect to the respective deviation signals based on an integration of a difference between each of the position error signals and the other corresponding position error signal. The controller further comprises a set of adding devices for adding the position error signal outputted from the respective deviation counters to the correction signals. The apparatus comprises a set of driving devices for driving the respective motors based on control signals outputted from the respective adding devices. The speed control of the motors is made based on a mean value of the position error of the first and second motor. This means that the speed control of both motors is based on the same value. The method aims that both motor shafts will reach the same position, possibly with the same control error. This means that the torques from two motors does not necessary becomes the same, and in a worst-case scenario both torques will counteract in order to try to reach the same position.

U.S. Pat. No. 5,646,495 shows a servo controller for driving an shaft using a main motor and a sub-motor. This server controller has a common position control for both motors. The position control is made based on a position command for the master motor and position feed back from the master motor. A speed difference between the main motor and the sub-motor is calculated, and a value for correction of torques is obtained based on this speed difference. The value for correction of torque is added to respective torque commands of both the main motor and the submotor, thereby making it possible to suppress vibrations occurring in the transmission mechanism. Thus, the server controller has a common speed control for both motors. The speed control is based on an average value for motor speed feedback from the first and the second motor. A problem with this type of server control is that it cannot handle vibrations in the sub-motor if the master motor is not vibrating. In order to reduce this problem the server controller is provided with a damping compensator.

US2001/0028228 shows a server controller capable of driving a single movable member by two motors. The server controller includes two control sections associated with respective motors and a damping controller. Each of the control sections has a position controller configured to output a speed command based on a common position command from a main controller and a position feedback value from an associated position detector, a speed controller configured to output a torque reference based on the speed command and a speed feedback value from an associated speed detector, and a current controller configured to output a voltage command based on the torque reference, and a current feedback value from an associated current detector. The damping controller outputs a current command correction value for compensating interference between the two motors based on the speed feedback values from the speed detectors for the two motors.

A common feature of the above-described controllers is that the same position commands, i.e. position references, are sent to the position controllers. The result is that all motors are driven to exactly the same position. This is no problem if the mechanical coupling between the motors is weak. However, if the mechanical coupling between the two motors is stiff, the torque between the motors will not be distributed equally if there is a mechanical offset or backlash between the motors. With larger misalignment, the result can be that motors are working against each other, one pushing and the other pulling in order to try to get the motors exactly to the reference position. In reality it is not possible to move the motors to exactly the same position, due to mechanical imperfections, backlash in gears, differences between the position detectors, or bad calibration of the detectors, which means that the motors are not in the correct position from the beginning. The consequence is that the two control sections try to get both motors exactly to the reference position, which is impossible, and the movable member becomes inclined instead of straight. Also the motors may counteract each other. Then large amounts of heat will be generated and there is a risk for the motors to become overheated

### OBJECTS AND SUMMARY OF THE INVENTION

The object of the present invention is to provide an improved server controller for controlling a plurality of motors including a master motor and a slave motor cooperatively driving a movable member, which reduces the drawbacks mentioned above.

This object is achieved by a servo controller according to claim 1.

Such a server controller is configured to control the master motor and the slave motor based on position references for the master motor. The servo controller comprises a master speed controller configured to calculate a reference torque for the master motor based on speed errors for the master motor, and a slave speed controller configured to calculate reference torques for the slave motor based on speed errors for the slave motor, wherein each of the reference torques includes a proportional torque part and an integral torque part. The invention is characterized in that the servo controller is configured to calculate each of the integral torque parts based on the speed errors of the master motor and the speed errors of the slave motor, such that the torques due to the integral torque parts will be distributed equally between the master and slave motors or according to a predefined ratio.

The server controller according to the invention does not try to move the motors to the same position; instead it distributes the torque between the motors. The motors will be moved so that the average position of the motors will be the same or close to the reference position. The major part of the steady state torque, such as torque due to gravity, friction, and external forces, will be distributed equally, or with a predefined ratio between the motors. This server controller will work independently of the degree of stiffness between the motors.

According to an embodiment of the invention, the servo controller is configured to calculate an integral torque part for the master motor based on the integral of the speed errors for the master motor, to calculate an integral torque part for the slave motor based on the integral of the speed errors for the slave motor, to calculate a mutual integral torque component based on the integral torque part for the master motor and the integral torque part for the slave motor, to determine a new integral torque part for the master motor and a new integral torque part for the slave motor based on the mutual integral torque component, and to update the integral torque part for the master motor and the integral torque part for the slave motor with the new integral torque parts. For example, the mutual integral torque component is calculated based on a mean value of the integral torque parts for the master motor and the slave motor. Advantageously, one of the speed controllers is configured to calculate the mutual integral torque component. This embodiment is easy to implement using normal PID controllers. No extra regulator is needed for calculating the integral torque parts.

According to an embodiment of the invention, the slave speed controller is configured to calculate said mutual integral torque component and to determine the new integral torque part of the slave motor and the new integral torque part of the master motor based on the mutual integral torque component, and to update the integral torque part of the master motor and the slave motor. It is advantageous to use the slave speed controller to calculate the integral torque parts and to update the integral torque parts of the master motor and the slave motor. If more than one slave motor is connected to the master motor, the updates of the integral torque parts are done only from the slaves to the master motor. The second slave motor uses the master value updated by the first slave. This embodiment is easy to implement and requires less code. In an alternative embodiment, the master can be used to calculate the new integral torque parts and to update the integral torque part of the master motor and the slave motors.

According to an embodiment of the invention, the server controller is configured to calculate the integral torque part for the master motor based on a first torque distribution ratio that depends on the relation between the maximum torque of the master motor and the total maximum torques of the motors, and to calculate the integral torque part for the slave motor based on a second torque distribution ratio that depends on the relation between the maximum torque for the slave motor and the total maximum torques of the motors. This embodiment makes it possible to distribute the torques between the motors if an unequal torque distribution is desired. This is advantageous, for example, if the motors are of different sizes.

According to an embodiment of the invention, the master speed controller is configured to calculate the speed errors for the master motor based on the difference between speed references and measured speed values for the master motor, and the slave speed controller is configured to calculate the speed errors for the slave motor based on the difference between speed references and measured speed values for the slave motor. As the speed control is based on speed feedback signals from the master motor as well as from the slave motor, it is possible for each of the speed controllers to suppress its own vibrations. Thus, the servo controller does not need any extra damping equipment.

According to an embodiment of the invention, the master position controller is configured to calculate the speed references for the master motor based on the position errors for the master motor and the position errors for slave motor, and the slave position controller is configured to calculate the speed references for the slave motor based on the position errors for the master motor and the position errors for slave motor. For example, the position controllers are configured to calculate the speed references based on the sum of the position errors for the master motor and slave motor. According to this embodiment, the position error is distributed between the master and slave motor. Thus, a uniform distribution of the torque between the motors is achieved. This embodiment is particularly useful in cases of large position errors.

According to an embodiment of the invention, the master position controller is configured to calculate the speed references for the master motor based on the position errors for the master motor multiplied by a first distribution factor, and the position errors for the slave motor multiplied by a second distribution factor. According to this embodiment, the position error is weighted between the master and slave motor. This embodiment makes it possible to determine the average positions of the shafts driven by the motors, and thereby to distribute the position error between the master and slave in a desired manner.

Another object of the present invention is to provide an improved method for controlling a plurality of motors, which method reduces the drawbacks mentioned above.

Such a method comprises: calculating speed references for the master motor and the slave motor based on position references for the master motor, calculating reference torques for the master motor as a sum of a proportional torque part and an integral torques part, based on the speed errors for the master motor, and calculating reference torques for the slave motor as a sum of a proportional torque part and an integral torque part, based on the speed errors for the slave motor. Each of the integral torque parts is calculated based on the speed errors for the master motor and the speed errors for the slave motor, such that the torques due to the integral torque parts will be distributed equally between the master and slave motors or according to a predefined ratio.

### BRIEF DESCRIPTION OF THE DRAWINGS

The invention will now be explained more closely by the description of different embodiments of the invention and with reference to the appended figures.

FIG. 1 shows a server controller for controlling two motors according to a first embodiment of the invention.

FIG. 2 shows a server controller for controlling two motors according to a second embodiment of the invention.

FIG. 3 shows a server controller for controlling three motors according to an embodiment of the invention.

FIG. 4 shows a server controller according to a third embodiment of the invention.

### DETAILED DESCRIPTION OF PREFERRED EMBODIMENTS OF THE INVENTION

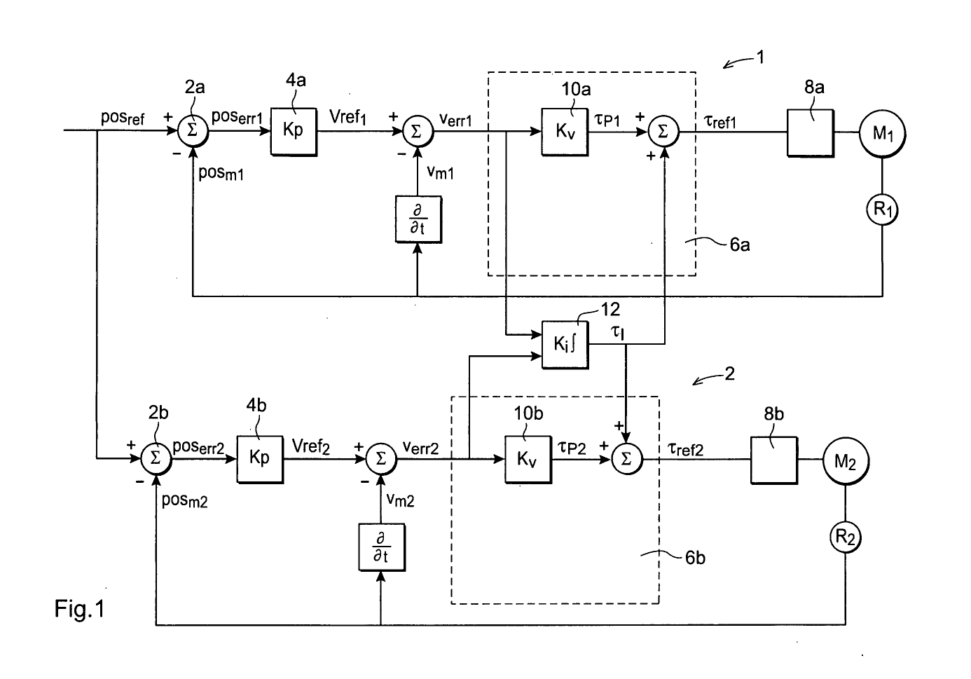

FIG. 1 shows a server controller for controlling two motors M₁, M₂ according to a first embodiment of the invention. The motors M₁ and M₂ are configured to cooperatively drive a movable member (not shown). The server controller comprises a first control section 1 configured to control the master motor M₁ and a second control section 2 configured to control the slave motor M₂. The server controller is provided with position references pos_{ref} from a main computer. The same position reference pos_{ref} is used for both motors. In this example, the motor M₁ is a master motor and the motor M₂ is a slave motor. The position reference is, for example, joint angles for a shaft driven by the motor.

Each control section 1,2 is provided with a position detector R₁, R₂ detecting the position of the shaft driven by the motor. The first control section 1 is provided with measured positions posₘ₁ from the master motor and the second control section 2 is provided with measured positions posₘ₂ from the slave motor. Each of the control sections 1, 2 includes a position controller 4a, 4b configured to calculate speed references Vref₁, Vref₂ based on the position errors posₑᵣᵣ₁, Posₑᵣᵣ₂. The position errors posₑᵣᵣ₁ for the master motor are calculated as the differences between the reference positions pos_{ref} for the master motor and the measured positions posₘ₁ for the master motor. The position errors posₑᵣᵣ₂ for the slave motor are calculated as the differences between the reference positions pos_{ref} for the master motor and the measured position posₘ₂ for the slave motor.

Further, each control section 1,2 is provided with a speed controller 6a, 6b configured to calculate a torque reference τ_{ref1}, τ_{ref2} for the motor based on a speed error vₑᵣᵣ₁, vₑᵣᵣ₂. The speed errors vₑᵣᵣ₁, vₑᵣᵣ₂ are calculated as a difference between a measured speed vₘ₁, vₘ₂ for the motors and the speed references v_{ref1}, v_{ref2} from the position controllers 4a, 4b. In this embodiment, the measured speeds vₘ₁, vₘ₂ are calculated by deriving d/dt the measured positions posₘ₁, posₘ₁ from the position detectors. Each control section 1,2 also includes a current controller 8a, 8b configured to provide the motors M₁, M₂ with current in dependence on the torque reference values τ_{ref1}, τ_{ref2} from the speed controller 6a-b.

The speed controllers 6a-b are PI-controllers. According to the definition of a PI-controller, the controller comprises a proportional element and an integrating element. The outputs from the proportional element and the integrating element are added and constitute the reference torques sent to the current controller. Thus, each of the speed controllers 6a, 6b is provided with a proportional element 10a, 10b configured to calculate a proportional torque part τₚ₁, τₚ₂ based on the speed errors vₑᵣᵣ₁, vₑᵣᵣ₂. According to this embodiment of the invention, the speed controllers 6a, 6b are provided with a common integral element 12 configured to calculate an integral torque part τ_{I} based on the speed errors vₑᵣᵣ₁, vₑᵣᵣ₂ of the master and slave motor.

The common integrating element 12 is configured to calculate a mutual integral torque component τ_{I} for the speed controllers by integrating the mean value of the speed errors vₑᵣᵣ₁ for the master motor and the speed error vₑᵣᵣ₂ from the slave motor. The integral is transformed to torque by multiplying it with Kᵢ.

τ_{I}=Kᵢ∫(vₑᵣᵣ₁+vₑᵣᵣ₂)/2

Kᵢ=Kᵥ/Tᵢ

Kᵥ=Speed control gain

Tᵢ=Integral time constant

The calculated torque value τ₁ is used as the integral torque part for the speed controller of the master motor as well as of the slave motor.

The reference torques τ_{ref1}, τ_{ref2} for the master and slave motors are calculated as the sum of the integral torque part τ_{I} and the proportional torque part τₚ₁, τₚ₁ for each motor.

τ_{ref1}=τₚ₁+τ_{I}

τ_{ref2}=τₚ₂+τ_{I}

According to this embodiment, the same integral torque part is used for all motors. With this layout the motors will move so that the average position of the motors will be the same as the reference position pos_{ref}. The major part of the steady state torque will be distributed equally between the motors. This servo controller will work independently of the degree or stiffness between the motors. The control sections 1, 2 are now dependent on a common integral element 12.

According to another embodiment, the calculated integral torque parts can be multiplied by a distributing ratio so that the integral parts of the torque references, and accordingly the torque, will be distributed between the motors with some predefined ratio K.

τ_{I1}=τ_{I}*K 0<K<1

τ_{I2}=τ_{I}*(1−K)

τ_{ref1}=τₚ₁+τ_{I1}

τ_{ref2}=τₚ₂+τ_{I2}

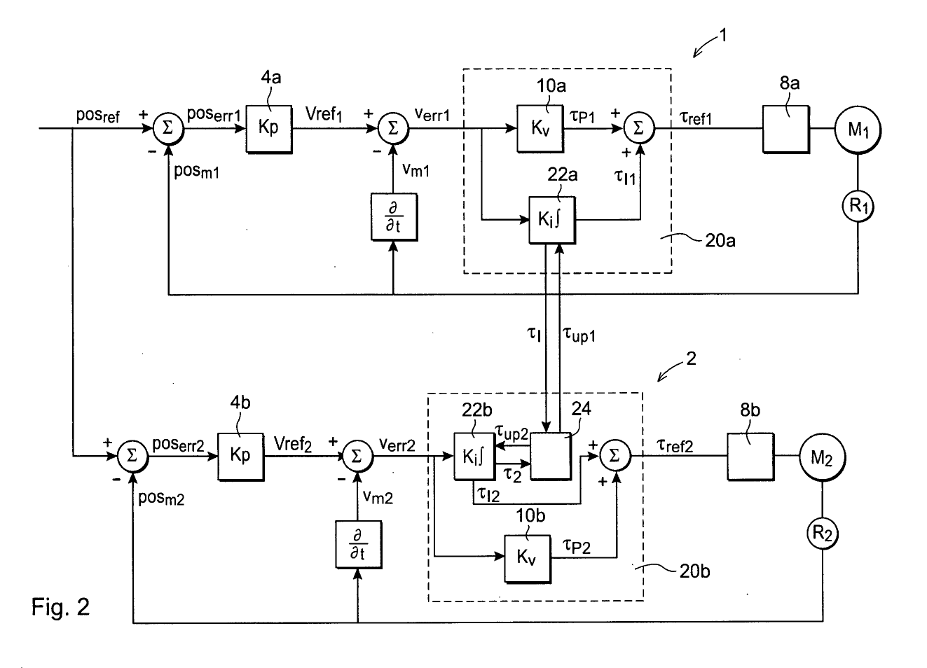

FIG. 2 shows another embodiment of a server controller according to the invention for controlling at least two motors. Components corresponding to those in FIG. 1 have been given the same reference numbers, and will not be described in more detail here. As can be seen in the drawing, each control section is provided with a speed controller 20a-b. Each of the speed controllers 20a, 20b is provided with a proportional element 10a-b and an integrating element 22a, 22b of its own. The integrating element 22a of the master speed controller is configured to calculate an integral torque value τ₁=Kᵢ∫vₑᵣᵣ₁ by integrating the speed errors of the master motor and multiplying with Kᵢ. The integrating element 22b of the slave speed controller is configured to calculate an internal torque value τ₂=Kᵢ∫vₑᵣᵣ₂ by integrating the speed error of the slave motor and multiplying with Kᵢ.

According to this embodiment of the invention, the slave speed controller 20b includes a mutual computing element 24 configured to retrieve the master integral torque value τ₁=Kᵢ∫vₑᵣᵣ₁ from the integrating element 22a, to calculate new integral torque values τᵤₚ₁, τᵤₚ₂ for the master and slave speed controllers based on the sum of the master integral torque value τ₁ and the slave integral torque value τ₂, and to update the integral torque value of the master integrating element 22a with the new master integral torque value τᵤₚ₁ and to update the integral torque value of the slave integrating element 22b with the new slave integral torque value τᵤₚ₂. The integrating elements 22a-b are configured to calculate the new integral torque parts τᵤₚ₁, τᵤₚ₂ based on the new integral torque values τ₁, τ₂ from the mutual computing element 24. The mutual computing element 24 can be seen as is temporary auxiliary help variable.

The master speed controller 20a is configured to calculate the torque reference τ_{ref1} as the sum of the integral torque part τ_{I1} from the integrating element 22a and the torque reference τₚ₁ from the proportional part 10a. The slave speed controller 20b is configured to calculate the torque reference τ_{ref2} as the sum of the integral torque part τ_{I2} from the integrating element 22b and the torque reference τₚ₂ from the proportional part 10b. Further, the integrating elements 22a-b are configured to continue to calculate the integral torque parts based on the new updated values τᵤₚ₁, τᵤₚ₂. Both the master and slave integrating elements 22a-b are updated by the slave speed controller. The updating of the integral torque values of the integrating elements 22a-b is made continuously with a certain frequency, for instance 0.5-10 kHZ. Preferably, the updating is made so often that the difference in the updating becomes small, for example, after each calculation of the master integral torque value τ₁=Kᵢ∫vₑᵣᵣ₁.

The mutual computing element 24 is configured to calculate a mutual integral torque component, for example a mean value of the integral torque values of the master motor and the slave motor, and to calculate the new integral torque values based on the mutual integral torque component.

Mutual integral torque component=(τ₁+τ₂)/2

τ₁=Kᵢ∫vₑᵣᵣ₁

τ₂=Kᵢ∫vₑᵣᵣ₂

The slave speed controller equalizes the integral values. During execution of the normal controller code, the common computing element 24 of the slave reads the integral torque value τ₁ of the speed controller of the master motor and the integral torque value τ₂ of the speed controller of the slave motor. A new integral torque value τᵤₚ₁ is calculated for the master controller and a new integral torque value τᵤₚ₂ is calculated for the slave controller. An advantage with this embodiment is that it is easy to implement using normal PID-controllers or PI-controllers, by equalizing the integral values between different PID-controllers.

In this embodiment, the same integral torque value is used to update the master speed controller as well as the slave speed controller. This means that the torque is distributed equally between the motors.

τᵤₚ₁=τᵤₚ₂=(τ₁+τ₂)/2

τ_{I1}=τᵤₚ₁

τ_{I2}=τᵤₚ₂

If an unequal torque distribution is desired, for example, if the motors have different sizes, the following algorithm can be used:

τᵤₚ₁=(τ₁+τ₂)*Tₘₐₓ₋ₘₐₛₜₑᵣ/(Tₘₐₓ₋ₛₗₐᵥₑ+Tₘₐₓ₋ₘₐₛₜₑᵣ)

τᵤₚ₂=(τ₁+τ₂)*Tₘₐₓ₋ₛₗₐᵥₑ/(Tₘₐₓ₋ₛₗₐᵥₑ+Tₘₐₓ₋ₘₐₛₜₑᵣ)

τᵤₚ₁ is the new integral torque part for the master

τᵤₚ₂ is the new integral torque part for slave

Tₘₐₓ₋ₘₐₛₜₑᵣ=maximum torque of the master motor

Tₘₐₓ₋ₛₗₐᵥₑ=maximum torque for the slave motor

If the shafts are rotated in opposite directions, the sign of the torques have to be considered.

This embodiment distributes the torque according to the size of the motors.

If it is desired that the master position becomes equal to the position reference, the update of the integrating element of the master is omitted. In this case:

τᵤₚ₁=(τ₁+τ₂)/2*Tₘₐₓ₋ₛₗₐᵥₑ/(Tₘₐₓ₋ₛₗₐᵥₑ+Tₘₐₓ₋ₘₐₛₜₑᵣ)

τᵤₚ₁=τ₁ (is not updated)

This solution easily supports more than one slave motor. All slaves equalize their integral values via the integrating element of the master.

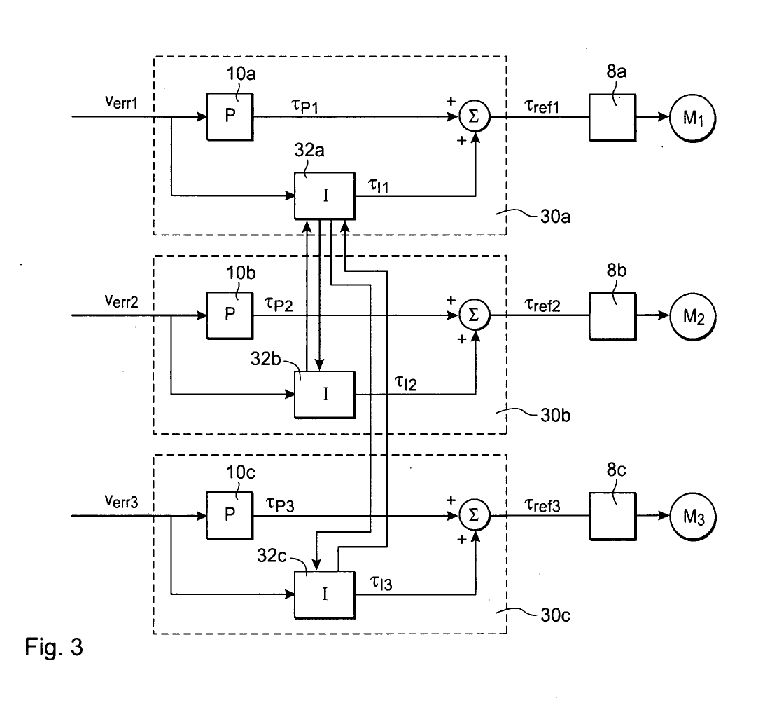

FIG. 3 shows the second embodiment implemented for a plurality of motors, in this case three motors M₁₋₃, cooperatively driving a movable member. One of the motors M₁ is master motor and the other motors are slave motors. If there is more than one slave motor, the updates of the integral values are only done from the slave speed controllers to the master speed controller. The second slave speed controller uses the master integral value updated by the first slave speed controller. The server controller includes three control sections, each control section including a speed controller 30a-c. The first speed controller 30a is configured to provide the current controller 8a of the master motor M₁ with torque references τ_{ref1} and the second speed controller 30b and the third speed controller 30c are configured to provide the current controllers 8b-c of the two slave motors M₂, M₃ with torque references τ_{ref2}, τ_{ref3}. Each of the speed controllers 30a-c is provided with a proportional element 10a-c and an integrating element 32a-c of its own. Each of the integrating elements 22a-c is configured to calculate an integral value by integrating the speed error of the motor. The calculations of the updated integral torque values are made in the same way as described above with reference to FIG. 2.

The integrating element 32b of the first slave motor M₂ is configured to retrieve the master integral torque values from the integrating element 32a, to calculate new integral torque values for the master and first slave speed controllers based on the sum of the master integral torque value τ₁=Kᵢ∫vₑᵣᵣ₁ and the first slave integral torque value τ₂=Kᵢ∫vₑᵣᵣ₂, and to update the integral value of the master integral element 32a with the new master integral torque value and to update the integral torque value τᵤₚ₁ of the first slave with the new slave integral torque value.

τᵤₚ₁₍ₙ₊₁₎=τᵤₚ₂₍ₙ₊₁₎=(τ₁+τ₂)/2

n=number of update

The integrating element 32c of the second slave motor M₃ is configured to retrieve the master integral torque value from the integrating element 32a, to calculate new integral torque values for the master and second slave speed controllers based on the sum of the master integral torque value τ₁=Kᵢ∫vₑᵣᵣ₁ and the second slave integral value τ₃=Kᵢ∫vₑᵣᵣ₃, and to update the integral value of the master integral element 32a with the new master integral torque value and to update the integral torque value of the second slave with the new slave integral torque value.

τᵤₚ₁₍ₙ₊₂₎=τᵤₚ₃₍ₙ₊₂₎=(τᵤₚ₁₍ₙ₊₁+τ₃)/2

The integral elements 32a-c are configured to use the new updated integral torque values as the integral torque parts τ_{I1}, τ_{I2}, τ_{I3}. The updating of the integral values of the integrating elements is made continuously with a certain frequency.

Tests have shown that the above-described updating algorithm converges very fast. The result is that the average final position of the motors will be the same as the reference position value pos_{ref}.

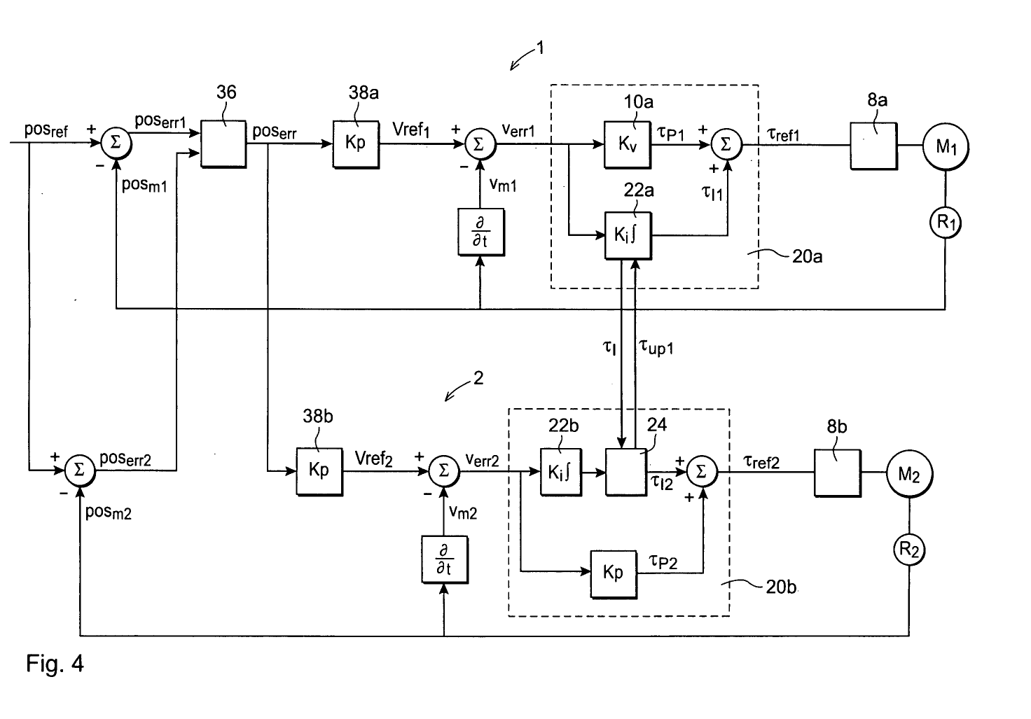

FIG. 4 shows a third embodiment of a server controller for controlling at least two motors M₁₋₂ according to the present invention. The speed controllers 20a-b are configured in the same way as described with reference to FIG. 2. In this embodiment the input to position controllers 38a, 38b is a common position error posₑᵣᵣ for the master motor and the slave motor. The common position error is calculated by a position error computer 36 based on the position error posₑᵣᵣ₁ for the master motor and the position error posₑᵣᵣ₂ for the slave motor. For example, the position error is calculated according to the following formula:

posₑᵣᵣ=posₑᵣᵣ₁*X+posₑᵣᵣ₂*(1−X) 0<x<1

Accordingly, if X=0 the common position error posₑᵣᵣ is the position error for the slave and if X=1, the common position error is equal to the position error for the master. If X is any value between 0 and 1, the position error for the master and slave is weighted between the master and slave motor. According to this embodiment, the position errors are equalized. This means that the motors will have the same position error. The common position error is, for example, the mean value of the position error of the master motor and the position error of the slave motor, i.e. x=0.5. Providing both position controllers with the same position error posₑᵣᵣ means that the speed controllers will be provided with the same speed reference v_{ref1}=v_{ref2}. This results in both integrating elements 22a-b attempting to drive the shaft driven by the motors to the same position. This is advantageous since the motors will provide the same torque at a standstill. Further, this embodiment achieves the advantage that the torques will be more equal for both motors, i.e. the torque error will be more equalized between the motors. This embodiment is particularly useful in cases of large position errors.

The present invention is not limited to the embodiments disclosed but may be varied and modified within the scope of the following claims.

1. A servo controller for controlling a plurality of motors including a master motor and a slave motor cooperatively driving a movable member, wherein the servo controller is configured to control the master motor and the slave motor based on position references for the master motor, the servo controller comprising:
a master speed controller configured to calculate a reference torque for the master motor based on speed errors for the master motor, and
a slave speed controller configured to calculate reference torques for the slave motor based on speed errors for the slave motor, wherein each of the reference torques is a sum of a proportional torque part and an integral torque part wherein the servo controller is configured to calculate each of said integral torque parts based on the speed errors of the master motor and the speed errors of the slave motor, such that the torques due to the integral torque parts will be distributed equally between the master and slave motors or according to a predefined ratio.

2. The servo controller according to claim 1, wherein the servo controller is configured to calculate an integral torque part for the master motor based on the integral of the speed errors for the master motor, to calculate an integral torque part for the slave motor based on the integral of the speed errors for the slave motor, to calculate a mutual integral torque component based on the integral torque part for the master motor and the integral torque part for the slave motor, to determine a new integral torque part for the master motor and a new integral torque part for the slave motor based on the mutual integral torque component, and to update the integral torque part for the master motor and the integral torque part for the slave motor with the new integral torque parts.

3. The servo controller according to claim 2, wherein the servo controller is configured to calculate said mutual integral torque component based on a mean value of the integral torque parts for the master motor and the slave motor.

4. The servo controller according to claim 3, wherein the slave speed controller is configured to calculate said mutual integral torque component and to determine the new integral torque part of the slave motor and the new integral torque part of the master motor based on the mutual integral torque component, and to update the integral torque part of the master motor and the slave motor.

5. The servo controller according to claims 4, wherein the master speed controller is configured to calculate the integral torque part based on the speed errors for the master motor, and the slave speed controller is configured to calculate the integral torque part based on the speed errors for the slave motor, to retrieve information on the integral torque part from the master speed controller, to calculate the mutual integral torque component based on the integral torque parts for the master motor and the slave motor, to determine a new integral torque part for the master motor and a new integral torque part for the slave motor based on the mutual integral torque component, and to update the integral torque parts for the master motor and the slave motor with the new integral torque parts.

6. The servo controller according to claim 1, wherein the servo controller is configured to calculate the integral torque part of the master motor based on a first torque distribution ratio, and to calculate the integral torque part for the slave motor based on a second torque distribution ratio.

7. The servo controller according claim 6, wherein the motors have different maximum torques, the servo controller is configured to calculate the integral torque part for the master motor based on a first torque distribution ratio that depends on the relation between the maximum torque of the master motor and the total maximum torques of the motors, and to calculate the integral torque part for the slave motor based on a second torque distribution ratio that depends on the relation between the maximum torque of the slave motor and the total maximum torques of the motors.

8. The servo controller according to claim 1, wherein the master speed controller is configured to calculate speed errors for the master motor based on the difference between speed references and measured speed values for the master motor, and the slave speed controller is configured to calculate speed errors for the slave motor based on the difference between speed references and measured speed values for the slave motor.

9. The servo controller according to claim 1, wherein the servo controller is configured to calculate position errors for the master motor based on the difference between position references for the master motor and measured positions for the master motor, and to calculate position errors for the slave motor based on said position references for the master motor and measured positions for the slave motor, and the servo controller comprises a master position controller configured to calculate speed references for the master motor based the position errors for the master motor, and a slave position controller configured to calculate speed references for the slave motor based on the position errors for the slave motor.

10. The servo controller according to claim 9, wherein the master position controller is configured to calculate said speed references for the master motor based on the position errors for the master motor and the position errors for the slave motor, and the slave position controller is configured to calculate said speed references for the slave motor based on the position errors for the master motor and the position errors for slave motor.

11. The servo controller according to claim 10, wherein the master position controller is configured to calculate said speed references for the master motor as a sum of the position errors for the master motor multiplied by a first distribution factor and the position errors for the slave motor multiplied by a second distribution factor.

12. A method for servo control of a plurality of motors including a master motor and a slave motor cooperatively driving a movable member, the method comprising:
calculating speed references for the master motor and the slave motor based on position references for the master motor,
calculating reference torques for the master motor, including a proportional torque part and an integral torques part, based on speed errors for the master motor, and
calculating reference torques for the slave motor, including a proportional torque part and an integral torque part, based on the speed errors for the slave motor, wherein each of the integral torque parts is calculated based on the speed errors for the master motor and the speed errors for the slave motor, such that the torques due to the integral torque parts will be distributed equally between the master and slave motors or according to a predefined ratio.

13. The method according to claim 12, further comprising:
calculating an integral torque part for the master motor based on the integral of the speed errors for the master motor,
calculating an integral torque part for the slave motor based on the integral of the speed errors for the slave motor,
calculating a mutual integral torque component based on the integral torque part for the master motor and the integral torque part for the slave motor,
determining a new integral torque part for the master motor and a new integral torque part for the slave motor based on the mutual integral torque component, and
updating the integral torque part for the master motor and the integral torque part for the slave motor with the new integral torque parts.

14. The method according to claim 13, wherein said mutual integral torque component is calculated based on a mean value of the integral torque parts for the master motor and the slave motor.

15. The method according to claim 12, wherein the integral torque part for the master motor is calculate based on a first torque distribution ratio, and the integral torque part for the slave motor is calculated based on a second torque distribution ratio.

16. The method according to claim 12, further comprising:
calculating the speed errors for the master motor based on the difference between speed references for the master motor and measured speed values for the master motor, and
calculating the speed errors for the slave motor based on the difference between speed references for the slave motor and measured speed values for the slave motor.

17. The method according to claim 12, further comprising:
calculating position errors (posₑᵣᵣ₁) for the master motor based on the difference between position references (pos_{ref}) for the master motor and measured positions (vₘ₁) for the master motor,
calculating speed references (v_{ref1}) for the master motor based on the position errors for the master motor,
calculating position errors (posₑᵣᵣ₂) for the slave motor based on said position references (pos_{ref}) for the master motor and measured positions (vₘ₂) for the slave motor, and
calculating speed references (v_{ref2}) for the slave motor based on the position errors for the slave motor.

18. The method according to claim 17, wherein said speed references for the master motor are calculated based on the position errors for the master motor and the position errors for the slave motor, and the speed references for the slave motor are calculated based on the position errors for the master motor and the position errors for the slave motor.

19. The method according to claim 18, wherein said speed references for the master motor and the slave motor are calculated as a sum of the position errors for the master motor multiplied by a first distribution factor and the position errors for the slave motor multiplied by a second distribution factor.

20. The method according to claim 13, further comprising:
calculating the integral torque part based on the speed errors for the master motor,
calculating the integral torque part based on the speed errors for the slave motor,
retrieving information on the integral torque part from the master speed controller,
calculating the mutual integral torque component based on the integral torque parts for the master motor and the slave motor,
determining a new integral torque part for the master motor and a new integral torque part for the slave motor based on the mutual integral torque component, and
updating the integral torque parts for the master motor and the slave motor with the new integral torque parts.
